(19) United States
(12) Patent Application Publication
(10) Pub. No.: US 2001/0055699 A1
(43) Pub. Date: Dec. 27, 2001

(54) Magnetic recording medium

(76) Inventors: Kazuo Kato, Kanagawa (JP); Hiroaki Doushita, Kanagawa (JP)

Correspondence Address: Stroock & Stroock & Lavan LLP, 180 Maiden Lane, New York, NY, 10038, US

(21) Appl. No.: 09/820,492

(22) Filed: Mar. 29, 2001

(30) Foreign Application Priority Data
Mar. 30, 2000 (JP) 2000-094605

(51) Int. Cl. G11B 5/714

(52) U.S. Cl. 428/694 BR

(57) ABSTRACT

The present invention aims to provide a magnetic recording medium for high-density magnetic recording suitable for reproducing with an MR head, which has improved electromagnetic characteristics, especially high-density recording characteristics and thermal asperity.

Herein disclosed is a magnetic recording medium comprising a substantially nonmagnetic lower layer and a magnetic layer containing a ferromagnetic powder dispersed in a binder provided in this order on a nonmagnetic substrate wherein said magnetic layer has an average thickness ranging from 0.02 μm to 0.1 μm and said magnetic layer has 10 or less projections having a diameter ranging from 5 μm to 100 μm and a height equal to or more than 100 nm per 900 cm on its surface.

### BACKGROUND OF THE INVENTION

1. Field of the Invention

The present invention relates to magnetic recording media for high-density recording suitable for reproducing with an MR head.

2. Description of Related Art

In the field of magnetic disks, personal computers come standard with a floppy disk drive for 2MBMF-2HD floppy disks using Co-modified iron oxide. However, their capacity has become insufficient to process today's rapidly increasing amount of data, and high-capacity floppy disks are demanded.

Also in the field of magnetic tapes, with the recent spread of office computers such as personal computers or work stations, magnetic tapes for recording computer data as external memory (the so-called backup tapes) have been extensively studied. For the commercialization of magnetic tapes for this purpose, an improvement in recording capacity is highly demanded to achieve high-capacity recording and downsizing especially along with the downsizing of computers and increase in data-processing capacity.

Magnetic recording media having a magnetic layer containing iron oxide, Co-modified iron oxide, CrO₂, a ferromagnetic metal powder or a hexagonal ferrite powder dispersed in a binder applied on a substrate have been widely used. Among them, a ferromagnetic metal powder and a hexagonal ferrite powder are known to have excellent high-density recording characteristics.

Conventional high-capacity disks using a ferromagnetic metal powder with excellent high-density recording characteristics include 10 MB MF-2TD and 21 MB MF-2SD while high-capacity disks using a hexagonal ferrite include 4 MB MF-2ED and 21 MB Fl optical, but none of them were sufficient in capacity and performance.

Recently, disk-like magnetic recording media comprising a thin magnetic layer and a functional nonmagnetic layer were developed and 100 MB floppy disks appeared. For example, JP-A No. 109061/93 discloses a disk-like magnetic recording medium comprising a magnetic layer having an Hc of 111440 A/m (1400 Oe) or more and a thickness of 0.5 μm or less and a nonmagnetic layer containing electrically conductive particles. JP-A No. 197946/93 discloses a disk-like magnetic recording medium containing an abrasive larger than the thickness of the magnetic layer. JP-A No. 290354/93 discloses a disk-like magnetic recording medium comprising a magnetic layer having a thickness of 0.5 μm or less with the variation in thickness of the magnetic layer being within ±15% whereby the surface electric resistance is defined. JP-A No. 68453/94 discloses a disk-like magnetic recording medium containing two abrasives having different particle sizes whereby the amounts of abrasives on the surface are defined.

In tape-like magnetic recording media, magnetic tapes for recording computer data as external memory (the so-called backup tapes) have been extensively studied and commercialized with the recent spread of office computers such as personal computers.

For example, magnetic tapes used in digital signal recording systems have a standardized format for each system, and magnetic tapes compatible for the so-called DLT-III, 3480, 3490, 3590, QIC, D8 or DDS-1 and DDS-2 are known. Magnetic tapes used in any system comprise a magnetic layer having a relatively thick single-layer structure of 2.0-3.0μm containing a ferromagnetic powder, a binder and an abrasive provided on one side of a substrate and a back coat layer for preventing winding disorder or keeping good running durability provided on the other side. However, such a magnetic layer having a relatively thick single-layer structure has the disadvantage of thickness loss resulting in output loss.

In order to improve the reproducing output loss resulting from thickness loss of the magnetic layer, it is known to make the magnetic layer thinner. For example, JP-A No. 182178/93 discloses a magnetic recording medium comprising a lower nonmagnetic layer containing an inorganic powder dispersed in a binder provided on a substrate and an upper magnetic layer having a thickness of 1.0 μm or less containing a ferromagnetic powder dispersed in a binder provided on said nonmagnetic layer while it is still wet. Based on this invention, magnetic tapes comprising an upper thin magnetic layer and a lower nonmagnetic layer have been used for high-density and high-capacity computer systems called DLT-IV or DDS-3.

However, a demand for high-capacity and high-density disk-or tape-like magnetic recording media is continuing, and it is becoming difficult to obtain satisfactory characteristics even by the above techniques.

As one direction to high densification, improvements in magnetic heads are proceeding. It is necessary to increase the number of turns of winding of the reproducing head to obtain a high reproducing output in conventional magnetic heads based on the principle of electromagnetic induction (inductive magnetic heads). However, an increase of inductance increases the resistance at high frequencies resulting in the problem of a decrease in reproducing output to limit high-density recording/reproducing.

Reproducing heads based on the principle of MR (magnetic resistance) were proposed and their use in hard disks or the like is staring. Magnetoresistive heads (MR heads) are expected to improve high-density recording/reproducing characteristics because they provide a reproducing output several times higher than obtained by inductive magnetic heads and significantly reduce apparatus noises such as impedance noise in the absence of inductive coils.

To suit the improvements of magnetic heads, magnetic recording media should be optimized. The magnetic flux density of the magnetic recording medium itself is required to be increased to further improve high densification, whereby the output is enhanced but the noise excessively grows in reproducing with an MR head, eventually failing in attaining a high S/N ratio. Another problem is that the linearity between the magnetic field strength and the resistance tends to be lost in MR heads so that output is lowered at high-range frequencies.

Another problem with MR heads is a phenomenon of a spike-like change in DC level which results from change in magnetic resistance due to the heat energy generated when the head hits a projection on the magnetic recording medium (thermal asperity: TA) . Frequent occurrence of TA may hinder error correction or even destroy the head itself. Thus, care must be taken to limit the incidence of TA as low as possible. In other words, recording/reproducing would be better with less projections on magnetic recording media. However, it has not been known what kind of shape and size of projections should be reduced to attain better recording/reproducing.

Therefore, it is an object of the present invention to provide a magnetic recording medium for high-density recording suitable for reproducing with an MR head, which has improved electromagnetic characteristics, especially high-density recording characteristics and thermal asperity.

### SUMMARY OF THE INVENTION

The present invention relates to a magnetic recording medium comprising a nonmagnetic lower layer and a magnetic layer containing a ferromagnetic powder and a binder provided in this order on a nonmagnetic substrate wherein said magnetic layer has an average thickness in the range of from 0.02 μm to 0.1 μm and said magnetic layer has 10 or less projections having a diameter in the range of from 5 μm to 100 μm and a height equal to or more than 100 nm per 900 cm² on its surface.

Preferred embodiments of the magnetic recording medium of the present invention are as follows.

(1) Said ferromagnetic powder is a ferromagnetic metal powder having an average major axis length equal to less than 0.1 μm and an aspect ratio equal to or more than 5.

(2) Said magnetic recording medium is a tape or disk for a digital signal recording system equipped with an MR reproducing head.

### DESCRIPTION OF THE PREFERRED EMBODIMENTS

Magnetic recording media of the present invention are explained in detail below.

[Magnetic layer]

In magnetic recording media of the present invention, the magnetic layer has an average thickness ranging from 0.02 to 0.1 μm. If the average thickness of the magnetic layer is less than 0.02 μm, the output decreases to fail in attaining a sufficient C/N or S/N ratio. If the average thickness of the magnetic layer is more than 0.1 μm, however, not only noise components increase but also the magnetic flux density from the magnetic layer is excessive for MR heads to saturate them, whereby output decreases to lower C/N or S/N ratio especially at high-frequency regions. The average thickness of the magnetic layer preferably ranges from 0.03 to 0.09 μm.

The average thickness of the magnetic layer herein can be determined as follows. A sample of a very thin section (having a thickness of about 80 nm) in the thickness direction of the magnetic recording medium is prepared by the ultra-thin section method known as a method for preparing a sample for transmission electron microscopy and the ultra-thin section is photographed under transmission electron microscopy (50000×) . The surface of the upper layer and the interface between the upper and lower layers on said photograph are traced on a film base, and 500 parallel lines are drawn at intervals of 0.025 μm in the thickness direction between the surface of the upper layer and the upper/lower layer interface to average the lengths of the lines as the average thickness of the magnetic layer.

Magnetic recording media of the present invention have 10 or less projections having a diameter of 5-100 μm and a height of 100 nm or more per 900 cm² on the surface of the magnetic layer. If more than 10 projections having said sizes exist per 900 cm² an MR head is more likely to hit projections during reproducing with the MR head whereby thermal asperity frequently occurs to cause error or even breakage of the MR head. The number of projections of the above sizes is not limited so far as it is 10/900 cm² or less including 0/900 cm².

Surface projections on the magnetic layer of the present invention are classified into projections resulting from the substrate and projections associated with coating layers, and the projections of both origins are controlled so that the surface projections on the magnetic layer may satisfy the above conditions.

Normally, minute projections are formed on the surface of the substrate to provide desired electromagnetic characteristics and durability or substrate handling properties. In order to form minute surface projections on the surface, the substrate contains fine-grained inorganic or organic fillers. In order to obtain desired electromagnetic characteristics, durability or handling properties, surface projections are formed by changing the particle size or particle size distribution of fillers or mixing fillers of different particle sizes. When the particle sizes of fine particles added to the substrate are relatively large; the particle size distribution is broad and contain large particles; fillers are insufficiently dispersed and contain agglomerates; or even if dispersed, they agglomerate during feeding to the film-forming apparatus or during film-forming, the so-called coarse projections are formed. Finer fillers are less dispersed or more likely to agglomerate. Therefore, surface projections on the substrate reflecting projections on the magnetic layer can be controlled by the nature, particle size, particle size distribution and dispersion conditions of fillers added to the substrate and filter conditions for removing coarse particles or agglomerates.

The influence of projections on the surface of the substrate can be reduced by increasing the thicknesses of coating layers, with the result that projections on the surface of the magnetic layer can be decreased.

Projections on a coating layer can be controlled by the particle size of a magnetic material, an abrasive or a carbon black contained in the upper layer and of a nonmagnetic powder, an abrasive or an inorganic powder such as a carbon black contained in the lower layer, the natures of the binder or a lubricant for dispersing them, kneading conditions for preparing solutions for upper and lower layers, dispersion conditions, the thicknesses of the coating layers, coating/drying conditions, calerdering conditions, surface treatment conditions of the surface of the magnetic layer, etc.

If said inorganic powder has a smaller particle size, it is less dispersed in a binder and tends to form projections. The binder used in combination also influences dispersion conditions and therefore the number of projections. As for kneading conditions, the kneaded products tend to be less dispersed to increase projections under strong kneading conditions with a small amount of a solvent added. On the contrary, projections tend to decrease under weak kneading conditions with a large amount of a solvent.

As for dispersion conditions, the dispersion period can be appropriately changed by the hardness, gravity or the like of dispersion media used for sand mill dispersion. If the dispersion period is short, the number of projections increases. If the dispersion period is too long, however, the number of projections increases because particles agglomerate with contaminants from wear of the disperser or dispersion media.

Normally, projections can be decreased under intense calendering conditions (high calendering pressure, temperature and roll hardness, and low speed).

Suitable surface treatments for the magnetic layer for floppy disks include a known method called varnishing involving polishing the surface of the magnetic layer against a polishing tape. Surface projections herein can be controlled as defined in the claims by controlling the grit of the polishing tape or the contact pressure.

Suitable methods for tapes include polishing with a polishing tape (wrapping tape blade method), sapphire blade method, diamond wheel method or the like disclosed in JP-A No. 259830/88. The related description of this publication is incorporated herein by reference. Surface projections can be controlled as defined in the claims by the choice of these methods or treating conditions therefor. Even if surface projections on the substrate or projections on coating layers are many, projections on the surface of the magnetic layer can be decreased by these surface treatments.

Thus, projections on the surface of the magnetic layer can be controlled by various methods, which can be appropriately combined to obtain the surface state as defined in magnetic recording media of the present invention.

The number of surface projections on magnetic recording media of the present invention can be determined as follows. The surface of the magnetic recording medium is observed with a differential interference microscope and projections are marked, and then the heights and widths of the projections are measured with HD-2000 from WYKO (objective lens 50×, intermediate lens 0.5×, measurement range 242 μm×184 μm) . The number of projections having a diameter measured as the width of 5-100 μm and a height of 100 nm or more is counted to determine the number of projections per 900 cm².

[Ferromagnetic Metal Powders]

A ferromagnetic powder used in the upper magnetic layer of the present invention is preferably a ferromagnetic alloy powder based on α-Fe. In addition to specific atoms, the ferromagnetic powder may contain other atoms such as Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B. Especially preferred ferromagnetic powder contains at least one of Al, Si, Ca, Y, Ba, La, Nd, Co, Ni, B, more preferably at least one of Co, Y, Al in addition to α-Fe. The Co content is preferably 0-40 at %, more preferably 15-35 at %, most preferably 20-35 at % on the basis of Fe. The Y content is preferably 1.5-15 at %, more preferably 3-12 at %. The Al content is preferably 1.5-15 at %, more preferably 3-12 at %. These ferromagnetic powders may be pretreated with a dispersant, a lubricant, a surfactant, an antistatic agent or the like described later before they are dispersed, as specifically described in JP-B Nos. 14090/69, 18372/70, 22062/72, 22513/72, 28466/71, 38755/71, 4286/72, 12422/72, 17284/72, 18509/72, 18573/72, 10307/64 and 39639/73 and U.S. Pat. Nos. 3,026,215, 3,031,341, 3,100,194, 3,242,005 and 3,389,014. The related descriptions of these publications are incorporated herein by reference.

The ferromagnetic alloy powders may contain a small amount of a hydroxide or oxide. Suitable ferromagnetic powders are obtained by known processes, including: reducing a composite organic acid salt (typically, oxalate) with a reducing gas such as hydrogen; reducing an iron oxide with a reducing gas such as hydrogen into Fe or Fe-Co particles or the like; thermally decomposing a metal carbonyl compound; reducing an aqueous ferromagnetic metal solution with a reducing agent such as sodium boron hydride, hypophosphite or hydrazine; or evaporating a metal in a low-pressure inert gas into fine powder. Thus obtained ferromagnetic alloy powder can be used after subjected to any of known slow oxidation treatments, such as dipping in an organic solvent followed by drying; dipping in an organic solvent and then feeding an oxygen-containing gas to form an oxide film on the surface followed by drying; or controlling the partial pressures of an oxygen gas and an inert gas to form an oxide film on the surface without using an organic solvent.

The ferromagnetic powder incorporated in the magnetic layer of the present invention suitably has a specific surface area of 40-80 m²/g, preferably 45-70 m²/g measured by the BET method. This range is preferred because noise can be decreased above 40 m²/g and good surface properties are obtained below 80 m²/g. The ferromagnetic powder contained in the magnetic layer of the present invention suitably has a crystallite size of 80-180 angstroms, preferably 100-180 angstroms, more preferably 110-175 angstroms. The ferromagnetic powder preferably has an average major axis length of 0.1 μm, more preferably 0.05 μm or more but 0.09 μm or less. The ferromagnetic powder preferably has an aspect ratio of 5 or more, more preferably 5-15, more preferably 6-12. The aspect ratio is represented by the ratio between the average major axis length measured with a transmission electron microscope and the crystallite size obtained by X-ray diffraction. The magnetic metal powder has a as of 100-180 A.m²/kg (100-180 emu/g), preferably 110-170 A.m²/kg (110-170 emu/g) , more preferably 125-160 A.m²/kg (125-160 emu/g) The metal powder suitably has a coercive force of 119400-318400 A/m (1500-4000 Oe), preferably 147260-278600 A/m (1800-3500 Oe), more preferably 159200-238800 A/m (2000-3000 Oe).

The ferromagnetic metal powder preferably has a moisture content of 0.01-2%. The moisture content of the ferromagnetic powder is preferably optimized depending on the nature of the binder. The pH of the ferromagnetic powder is preferably optimized depending on the binder used in combination, in the range of 4-12, preferably 6-10. If desired, the ferromagnetic powder may be treated with Al, Si, P or oxides thereof or the like. The amount thereof is normally 0. 1-10% by weight of the ferromagnetic powder. Surface treatments are preferred because adsorption of a lubricant such as a fatty acid becomes 100 mg/m² or less. The ferromagnetic powder may contain soluble inorganic ions such as Na, Ca, Fe, Ni or Sr. Preferably, it is essentially free from these ions, but its characteristics are scarcely affected at 200 ppm or less. The ferromagnetic powders used in the present invention preferably have less voids, such as 20% by volume or less, more preferably 5% by volume or less. The ferromagnetic powders may have any of needle-, rice grain-and spindle-like shapes so far as the particle size shown above is satisfied. The SFD of ferromagnetic powders themselves is preferably lower, and preferably 0.6 or less. The ferromagnetic powders preferably have a narrow Hc distribution. SFDs of 0.6 or less are preferred for high-density digital magnetic recording because good electromagnetic characteristics, high output and sharp magnetization inversion are obtained with decreased peak shifts. Hc distribution of ferromagnetic metal powders can be narrowed by improving the particle size distribution of goethite or preventing sintering.

Examples of a carbon black used in the upper layer of the present invention include furnace blacks for rubber use, thermal blacks for rubber use, carbon blacks for coloring agents, acetylene blacks or the like. They preferably have a specific surface area of 5-500 m²/g, a DBP oil absorption of 10-400ml/100 g, a particle diameter of 5 nm-300 nm, a pH of 2-10, a moisture content of 0.1-10% by weight and a tap density of 0.1-1 g/ml. Specific examples of carbon blacks used herein include BLACKPEARLS 2000, 1300, 1000, 900, 800, 700 and VULCAN XC-72 manufactured by Cabot Corporation; #80, #60, #55, #50 and #35 manufactured by Asahi Carbon Co., Ltd.; #2400B, #2300, #900, #1000, #30, #40 and #10B manufactured by Mitsubishi Chemical Corporation; and CONDUCTEX SC, RAVEN 150, 50, 40 and 15 manufactured by Columbian Chemicals Company. These carbon blacks may be surface-treated with a dispersant or grafted with a resin or partially graphitized on their surfaces. Alternatively, they may be dispersed in a binder before they are added to a magnetic coating (paint). These carbon blacks can be used alone or in combination.

When a carbon black is used, it preferably represents 0.1-30% by weight of the amount of a ferromagnetic powder.

Carbon blacks have an antistatic effect, friction coefficient-lowering effect, light protection-conferring effect, film strength-improving effect or the like on the magnetic layer depending on the carbon blacks specifically used. Therefore, these carbon blacks used herein can obviously vary in nature, amount and combination from magnetic to lower layers to meet the purpose on the basis of the characteristics shown above such as particle size, oil absorption, conductivity or pH. As for a carbon black that can be used in the magnetic layer of the present invention, see “Carbon Black Handbook” edited by Carbon Black Association, for example.

[Nonmagnetic Layer]

Next, the lower layer is explained in detail below. The inorganic powder used in the lower layer of the present invention is a nonmagnetic powder that can be selected from inorganic compounds such as metal oxides, metal carbonates, metal sulfates, metal nitrides, metal carbides and metal sulfides. Suitable inorganic compounds include, for example, α-alumina having an α-conversion degree of 90% or more, β-alumina, γ-alumina, θ-alumina, silicon carbide, chromium oxide, cerium oxide, α-iron oxide, hematite, goethite, corundum, silicon nitride, titanium carbide, titanium dioxide, silicon dioxide, tin oxide, magnesium oxide, tungsten oxide, zirconium oxide, boron nitride, zinc oxide, calcium carbonate, calcium sulfate, barium sulfate and molybdenum disulfide, which can be used alone or in combination. In respects of the narrow particle size distribution, abundance of function-conferring means or the like, especially preferred are titanium dioxide, zinc oxide, iron oxide and barium sulfate, among which titanium dioxide and α-iron oxide are more preferred. These nonmagnetic powders preferably have a particle size of 0.005-0.5 μm, but the same effect can be obtained by combining nonmagnetic powders having different particle sizes or by widening the particle diameter distribution of even a single nonmagnetic powder, if necessary. Especially preferred nonmagnetic powders have a particle size of 0.01-0.2 μm. Particularly when nonmagnetic powders are granulated metal oxides, the average particle size is preferably 0.08 μm or less. Acicular metal oxides preferably have a major axis length of 0.2 μm or less, more preferably 0.15 μm or less, still more preferably 0.1 μm or less. Nonmagnetic powders suitably have an aspect ratio of 2-20, preferably 3-10. The tap density is 0.05-2 g/ml, preferably 0.2- 1.5 g/ml. The moisture content of nonmagnetic powders is 0.1-5% by weight, preferably 0.2-3% by weight, more preferably 0.3-1.5% by weight. The pH of nonmagnetic powders is 2-11, preferably 5.5-10. These powders show good dispersion and high mechanical strength of the resulting coating films because of the high adsorption to functional groups.

The specific surface area of nonmagnetic powders is 1-100 m²/g, preferably 5-80 m²/g, more preferably 10-70 m²/g. The crystallite size of nonmagnetic powders is preferably 0.004 μm-1 μm, more preferably 0.04 μm-0.1 μm. The oil absorption utilizing DBP (dibutyl phthalate) is 5-100 ml/100g, preferably 10-80 ml/100 g, more preferably 20-60 ml/100 g. The specific gravity is suitably 1-12, preferably 3-6. They may have any of acicular, spherical, polygonal and plate-like shapes. The Mohs hardness is preferably 4 or more but 10 or less. The SA (stearic acid) absorption of nonmagnetic powders is suitably 1-20 μmol/m², preferably 2-15 μmol/m², more preferably 3-8 μmol/m². These nonmagnetic powders are preferably surface-treated to contain Al₂O₃, SiO₂, TiO₂, ZrO₂, SnO₂, Sb₂O₃,ZnO or Y₂O₃. Especially preferred for dispersibility are Al₂O₃, SiO₂, TiO₂ and ZrO₂, more preferably Al₂O₃, SiO₂ and ZrO₂. These may be used in combination or alone to form a surface-coating layer by coprecipitation or initially depositing alumina on the surfaces of powders and then silica or vice versa depending on the purpose. The surface-coating layer may be a porous for some purposes, but preferably homogeneous and dense in general.

Specific examples of the nonmagnetic powder used in the lower layer of the present invention include Nanotite manufactured by Showa Denko K. K.; HIT-100 and ZA-G1 manufactured by Sumitomo Chemical Co., Ltd.; (α-hematite DPN-250, DPN-250BX, DPN-245, DPN-270BX, DPN-500BX, DBN-SA1 and DBN-SA3 manufactured by Toda Kogyo Corp.; titanium oxide TTO-51B, TTO-55A, TTO-55B, TTO-55C, TTO-55S, TTO-55D, SN-100, α-hematite E270, E271, E300 and E303manufactured by Ishihara Sangyo Kaisha, Ltd.; STT-4D, STT-30D, STT-30 and STT-65C and α-hematite α-40 manufactured by Titan Kogyo K.K.; MT-100S, MT-100T, MT-150W, MT-500B, MT-600B, MT-1OOF and MT-50OHD manufactured by Tayca Corporation; FINEX-25, BF-1, BF-10, BF-20 and ST-M manufactured by Sakai Chemical Industry Co., Ltd.; DEFIC-Y and DEFIC-R manufactured by Dowa Mining Co., Ltd.; AS2BM and TiO2P25 manufactured by Nippon Aerosil Co., Ltd.; 100A and 500A manufactured by Ube Industries, Ltd.; as well as sintered products thereof. Especially preferred nonmagnetic powders are titanium dioxide and α-iron oxide.

A carbon black can be mixed into the lower layer to attain not only known effects such as lowered Rs or decreased light transmittance but also a desired Micro-Vickers hardness. Suitable carbon blacks include furnace blacks for rubber use, thermal blacks for rubber use, carbon blacks for coloring agents, acetylene blacks or the like.

A carbon black for the lower layer has a specific surface area of 100-500 m²/g, preferably 150-400 m²/g and a DBP oil absorption of 20-400 ml/100 g, preferably 30-400 ml/100g. The particle size of carbon blacks is 5 nm-80 nm, preferably 10-50 nm, more preferably 10-40 nm. Carbon blacks preferably have a pH of 2-10, a moisture content of 0.1-10%, and a tap density of 0.1- 1 g/ml. Specific examples of the carbon black used herein include BLACKPEARLS 2000, 1300, 1000, 900, 800, 880, 700 and VULCAN XC-72 manufactured by Cabot Corporation; #3050B, #3150B, #3250B, #3750B, #3950B, #950, #650B, #970B, #850B, MA-600, MA-230, #4000 and #4010 manufactured by Mitsubishi Chemical Corporation; CONDUCTEX SC, RAVEN8800, 8000,7000, 5750, 5250, 3500, 2100, 2000, 1800, 1500, 1255 and 1250 manufactured by Columbian Chemicals Company; and Ketjen Black EC manufactured by Akzo Nobel. These carbon blacks may be surface-treated with a dispersant or grafted with a resin or partially graphitized on their surfaces. Alternatively, they may be dispersed in a binder before they are added to a coating. These carbon blacks can be used in the range not exceeding 50% by weight of the above inorganic powder and not exceeding 40% by weight of the total weight of the nonmagnetic layer. These carbon blacks can be used alone or in combination. As for a carbon black that can be used herein, see “Carbon Black Handbook” edited by Carbon Black Association, for example.

The lower layer can also contain an organic powder for some purposes, including acrylic-styrene resin powders, benzoguanamine resin powders, melamine resin powders and phthalocyanine pigments as well as polyolefin resin powders, polyester resin powders, polyamide resin powders, polyimide resin powders and polyfluoroethylene resins, which can be prepared by the processes described in JP-A Nos. 18564/87 and 255827/85. The related descriptions of these publications are incorporated herein by reference.

Binder resins, lubricants, dispersants, additives, solvents, dispersion methods and others used in the lower layer may be the same as described below for the magnetic layer. Particularly, the amounts and natures of binder resins, additives and dispersants can be determined by known techniques relating to magnetic layers.

[Binders]

Binders, lubricants, dispersants, additives, solvents, dispersion methods and others used in the magnetic and nonmagnetic layers and the back layer of the present invention may be the same as those for known magnetic and nonmagnetic layers and back layers. Particularly, the amounts and natures of binders, additives and dispersants can be determined by known techniques relating to magnetic layers.

Binders used herein include known thermoplastic resins, thermosetting resins, reactive resins and mixtures thereof. Suitable thermoplastic resins have a glass transition temperature of −100 to 150° C., a number average molecular weight of 1,000 to 200,000, preferably 10,000 to 100,000, and a polymerization degree of about 50 to 1,000.

Examples thereof include polymers or copolymers containing vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, vinyl acetal, vinyl ethers or the like as base units; polyurethane resins; and various rubber-based resins. Suitable thermosetting resins or reactive resins include phenol resins, epoxy resins, polyurethane curing resins, urea resins, melamine resins, alkyd resins, acrylic reactive resins, formaldehyde resins, silicone resins, epoxy-polyamide resins, mixtures of polyester resins and isocyanate prepolymers, mixtures of polyester polyols and polyisocyanates, mixtures of polyurethanes and polyisocyanates and the like. These resins are described in detail in “Plastic Handbook”, published by Asakura Shoten. Known electron radiation curing resins can also be used in various layers. Examples and the preparation process thereof are described in detail in JP-A No. 256219/87. The related description of this publication is incorporated herein by reference. These resins can be used alone or in combination. Preferred are combinations of a polyurethane resin or a polyisocyanate with at least one member selected from vinyl chloride resins, vinyl chloride-vinyl acetate copolymers, vinyl chloride-vinyl acetate-vinyl alcohol copolymers, vinyl chloride-vinyl acetate-maleic anhydride copolymers.

Polyurethane resins may have a known structure such as polyester-polyurethane, polyether-polyurethane, polyether-polyester-polyurethane, polycarbonate-polyurethane, polyester-polycarbonate-polyurethane, polycaprolactone-polyurethane or the like. If desired, all the binders shown here may preferably contain at least one polar group selected from —COOM, —SO₃M, —OSO₃M, —P═O(OM)₂, —O−P═O(OM)₂ (where M represents a hydrogen atom or an alkali metal base), —OH, —NR₂, ═N⁺R₃ (where R represents a hydrocarbon group), an epoxy group, —SH, —CN or the like introduced via copolymerization or addition reaction to obtain more excellent dispersibility and durability. The amount of suchpolar groups ispreferably 10⁻¹ to 10⁻⁸ mol/g, more preferably 10⁻² to 10⁻⁶ mol/g.

Specific examples of these binders used herein include VAGH, VYHH, VMCH, VAGF, VAGD, VROH, VYES, VYNC, VMCC, XYHL, XYSG, PKHH, PKHJ, PKHC and PKFE manufactured by Union Carbide Corporation; MPR-TA, MPR-TA5, MPR-TAL, MPR-TSN, MPR-TMF, MPR-TS, MPR-TM and MPR-TAO manufactured by Nissin Chemical Industry Co., Ltd.; 1000W, DX80, DX81, DX82, DX83 and 1OOFD manufactured by Denki Kagaku Kogyo K.K.; MR-104, MR-105, MR110, MR100, MR555 and 400X-110A manufactured by Nippon Zeon Co., Ltd.; Nippollan N2301, N2302 and N2304 manufactured by Nippon Polyurethane Industry Co., Ltd.; Pandex T-5105, T-R3080, T-5201, Burnock D-400, D-210-80, Crisvon 6109 and 7209 manufactured by Dainippon Ink & Chemicals, Incorporated; Vylon UR8200, UR8300, UR-8700, RV530 and RV280 manufactured by Toyobo Co., Ltd.; Daipheramine 4020, 5020, 5100, 5300, 9020, 9022 and 7020 manufactured by Dainichiseika Color & Chemicals Mfg. Co., Ltd.; MX 5004 manufactured by Mitsubishi Chemical Corporation; Sunprene SP-150 manufactured by Sanyo Chemical Industries, Ltd.; Salan F310 and F210 manufactured by Asahi Chemical Industry Co., Ltd. and the like.

Binders in the nonmagnetic and magnetic layers of the present invention are present in the range of 5-50%, preferably 10-30% of the nonmagnetic powder or magnetic powder. Preferably, 5-30% of a vinyl chloride resin, 2-20% of a polyurethane resin and 2-20% of a polyisocyanate are used in combination, but a polyurethane alone or combinations of only a polyurethane and an isocyanate may be used when head corrosion occurs by minor dechlorination. Polyurethanes used herein preferably have a glass transition temperature of −50 to 150° C., preferably 0° C. to 100° C., an elongation at break of 100 to 2,000%, a breaking stress of 0.05 to 10 Kg/mm², and a yield stress of 0.05 to 10 Kg/mm².

Magnetic recording media of the present invention comprises two or more layers. Therefore, the amount of binders, the amounts of vinyl chloride resins, polyurethane resins, polyisocyanates or other resins in the binders, the molecular weight of each resin forming the magnetic layer, the amount of polar groups or the aforementioned physical properties of resins or other factors can naturally vary or should rather be optimized from nonmagnetic to magnetic layers, if necessary, by applying known techniques relating to multilayer magnetic systems. For example, varying amounts of binders may be added to various layers by increasing the amount of binder in the magnetic layer to reduce scuff marks on the surface of the magnetic layer or increasing the amount of binder in the nonmagnetic layer to provide flexibility for better head touch.

Suitable polyisocyanates for use herein include isocyanates such as tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate, triphenylmethane triisocyanate; products of these isocyanates with polyalcohols; or polyisocyanates producted by condensation of isocyanates. These isocyanates are commercially available under trade names Coronate L, Coronate HL, Coronate 2030, Coronate 2031, Millionate MR and Millionate MTL from Nippon Polyurethane Industry Co. Ltd.; Takenate D-102, Takenate D-11ON, Takenate D-200 and Takenate D-202 from Takeda Chemical Industries, Ltd.; Desmodule L, Desmodule IL, Desmodule N and Desmodule HL from Sumitomo Bayer Urethane Co., Ltd. etc., which may be used alone or as a combination of two or more by taking advantage of the difference in curing reactivity.

Suitable abrasives for use herein are typically known materials having a Mohs hardness of 6 or more such as α-alumina having an α-conversion degree of 90% or more, β-alumina, silicon carbide, chromium oxide, cerium oxide, α-iron oxide, corundum, artificial diamond, silicon nitride, silicon carbide, titanium carbide, titanium dioxide, silicon dioxide and boron nitride, which can be used alone or in combination. Complexes of these abrasives may also be used (which are obtained by surface-treating one abrasive with another abrasive). These abrasives may sometimes contain other compounds or elements than main components, but the effect is not affected so far asmain components represent 90% by weight or more. Abrasives preferably have a tap density of 0.3-2 g/ml, a moisture content of 0.1-5% by weight, a pH of 2-11 and a specific surface area of 1-30 m²/g. Abrasives used herein may have any of acicular, spherical and cubic shapes, but preferably have a partially angular shape to provide high abrasive properties. Specific examples of abrasives used herein include AKP-20, AKP-30, AKP-50, HIT-50, HIT-55, HIT-60A, HIT-70 and HIT-100 manufactured by Sumitomo Chemical Co., Ltd.; G5, G7 and S-1 manufactured by Nippon Chemical Industrial Co., Ltd.; and TF-100 and TF-140 manufactured by Toda Kogyo K.K. Abrasives used herein can obviously vary in nature, amount and combination from (upper and lower) magnetic to nonmagnetic layers to meet the purpose. These abrasives may be preliminarily dispersed in a binder before they are added into a magnetic coating.

Additives used herein have a lubricating effect, antistatic effect, dispersing effect, plasticizing effect or the like. Suitable additives include molybdenum disulfide; tungsten-graphite disulfide; boron nitride; graphite fluoride; silicone oils; silicones having a polar group; fatty acid-modified silicones; fluorine-containing silicones; fluorine-containing alcohols; fluorine-containing esters; polyolefins; polyglycols; alkyl phosphoric acid esters and alkali metal salts thereof; alkyl sulfuric acid esters and alkali metal salts thereof; polyphenyl ethers; fluorine-containing alkyl sulfuric acid esters and alkali metal salts thereof; C10-24 monobasic fatty acids optionally branched and optionally containing an unsaturated bond andmetal (e.g., Li, Na, K, Cu) salts thereof; C12-22monohydric, dihydric, trihydric, tetrahydric, pentahydric and hexahydric alcohols optionally branched and optionally containing an unsaturated bond; C12-22 alkoxy alcohols optionally branched and optionally containing an unsaturated bond; monofatty acid esters or difatty acid esters or trifatty acid esters formed from a C10-24 monobasic fatty acid optionally branched and optionally containing an unsaturatedbond and any one of C2-12 monohydric, dihydric, trihydric, tetrahydric, pentahydric and hexahydric alcohols optionally branched and optionally containing an unsaturated bond; fatty acid esters of monoalkyl ethers of alkylene oxide polymers; C8-22 fatty acid amides; and C8-22 aliphatic amines.

Specific examples of these additives include lauric acid, myristic acid, palmitic acid, stearic acid, behenic acid, butyl stearate, oleic acid, linolic acid, linolenic acid, elaidic acid, octyl stearate, amyl stearate, iso-octyl stearate, octyl myristate, butoxyethyl stearate, anhydrosorbitanmonostearate, anhydrosorbitan distearate, anhydrosorbitan tristearate, oleyl alcohol, and lauryl alcohol. Other suitable additives include nonionic surfactants based on alkylene oxides, glycerin, glycidol or alkyl phenol-ethylene oxide adducts; cationic surfactants based on cyclic amines, ester amides, quaternary ammonium salts, hydantoin derivatives, heterocycles, phosphonium or sulfoniums; anionic surfactants containing an acidic group such as carboxylate, sulfonate, phosphate, sulfuric acid ester and phosphoric acid ester groups; and ampholytic surfactants based on amino acids, amino sulfonic acids, sulfuric or phosphoric acid esters of amino alcohols or alkyl betaines.

These surfactants are described in detail in “Surfactants Handbook” (published by Sangyo Tosho Co., Ltd.). These lubricants, antistatic agents or the like need not be 100% pure but may contain impurities such as isomers, unreacted materials, side reaction products, decomposition products and oxides in addition to main components. The content of these impurities is preferably 30% or less, more preferably 10% or less.

These lubricants and surfactants used herein can vary in nature and amount from lower to upper magnetic layers, if desired. For example, fatty acids having different melting points or esters having different boiling points or polarities can be used in the lower and upper magnetic layers to control bleed-through, or the amount of surfactants can be controlled to improve coating stability, or the amount of lubricants added to the nonmagnetic layer can be increased to improve a lubricating effect, though these examples are not limitative as a matter of course. Additives used herein may be totally or partially added in any step of the preparation process of magnetic coatings. For example, they may be mixed with the ferromagnetic powder before kneading, or may be added during the step where the ferromagnetic powder, binders and solvents are kneaded, or may be added during or after dispersion, or may be added immediately before coating. For some purposes, additives may be partially or totally applied by simultaneous or sequential coating after the magnetic layer has been applied. For other purposes, lubricants may be applied on the surface of the magnetic layer after completion of calendering or slitting.

Commercial products of these lubricants used herein include NAA-102, NAA-415, NAA-312, NAA-160, NAA-180, NAA-174, NAA-175, NAA-222, NAA-34, NAA-35, NAA-171, NAA-122, NAA-142, NAA-160, NAA-173K, Hydrogenated Castor Oil Fatty Acid, NAA-42, NAA-44, Cation SA, Cation MA, Cation AB, Cation BB, Nymeen L-201, Nymeen L-202, Nymeen S-202, Nonion E-208, Nonion P-208, Nonion S-207, Nonion K-204, Nonion NS-202, Nonion NS-210, Nonion HS-206, Nonion L-2, Nonion S-2, Nonion S-4, Nonion 0-2, Nonion LP-20R, Nonion PP-40R, Nonion SP-60R, Nonion OP-80R, Nonion OP-85R, Nonion LT-221, Nonion ST-221, Nonion OT-221, Monogly MB, Nonion DS-60, Anon BF, Anon LG, Butyl Stearate, Butyl Laurate and Erucic Acid manufactured by NOF Corporation; Oleic Acid manufactured by Kanto Chemical Co., Ltd.; FAL-205 and FAL-123 manufactured by Takemoto Oil & Fat Co., Ltd.; NJLUB LO, NJLUB IPM and Sansosyzer E4030 manufactured by New Japan Chemical Co., Ltd.; TA-3, KF-96, KF-96L, KF96H, KF410, KF420, KF965, KF54, KF50, KF56, KF907, KF851, X-22-819, X-22-822, KF905, KF700, KF393, KF-857, KF-860, KF-865, X-22-980, KF-101, KF-102, KF-103, X-22-3710, X-22-3715, KF-910 and KF-3935 manufactured by Shin-Etsu Chemical Co., Ltd.; Armid P, Armid C and Armoslip CP manufactured by Lion Armour Co., Ltd.; Duomine TDO manufactured by Lion Corporation; BA-41G manufactured by Nisshin Oil Mills, Ltd.; Profan 2012E, Newpol PE61, Ionet MS-400, Ionet MO-200, Ionet DL-200, Ionet DS-300, Ionet DS-1000 and Ionet DO-200 manufactured by Sanyo Chemical Industries, Ltd.

[Layer Structure]

An undercoat layer may be provided between the nonmagnetic flexible substrate and the nonmagnetic or magnetic layer to improve adhesion. The undercoat layer has a thickness of 0.01-0.5 μm, preferably 0.02-0.5 μm. The present invention may normally include double-and single-sided magnetic disk-like media provided with a nonmagnetic layer and a magnetic layer on both sides or one side of the substrate. In the latter case, a back coat layer may be provided on the side opposite to the nonmagnetic and magnetic layers to add antistatic or anti-curling effects. The thickness of the back coat layer is 0.2-1.5 μm, preferably 0.3-0.8 μm. These undercoat layer and back coat layer are known.

In magnetic recording media of the present invention, the magnetic layer suitably has an average thickness of 0.02-0.1 μm, preferably 0.03-0.09 μm, as described above. The object of present invention can be achieved with either a single or multiple magnetic layer.

In magnetic recording media of the present invention, the lower nonmagnetic layer suitably has a thickness of 0.2 μm or more but 5.0 μm or less, preferably 0.3 μm or more but 3.0 μm or less, more preferably 1.0 μm or more but 2.5 μm or less.

[Back Coat Layer]

Generally, magnetic tapes for recording computer data highly require repeated running performance as compared with videotapes and audiotapes. In order to keep such high running durability, the back coat layer preferably contains a carbon black and an inorganic powder.

Preferably, two carbon blacks having different average particle sizes are used in combination. In this case, a fine-grained carbon black having an average particle size of 10-20 mm and a coarse-grained carbon black having an average particle size of 230-300 μm are preferably used in combination. Generally, the addition of such a fine-grained carbon black allows the back coat layer to be maintained at low surface electric resistance and low light transmittance. In many magnetic recording media which take advantage of the light transmittance of the tape to generate an operation signal, the addition of a fine-grained carbon black is especially effective. Fine-grained carbon blacks are generally excellent in holding a liquid lubricant to contribute to the reduction of the friction coefficient when combined with a lubricant. On the other hand, coarse-grained carbon blacks having a particle size of 230-300 nm serve as a solid lubricant and form minute projections on the surface of the back layer to reduce the contact area, thus contributing to the reduction of the friction coefficient. However, coarse-grained carbon blacks have the disadvantage that they tend to be separated from the back coat layer during tape sliding to increase the error rate in harsh running systems.

Specific examples of commercially available fine-grained carbon blacks include RAVEN 2000B (18 nm) and RAVEN 1 50B (17 nm) from Columbian Chemicals Company; BP800 (17 nm) from Cabot Corporation; PRINNTEX 90 (14nm) PRINTEX 95 (15 nm), PRINTEX 85 (16 nm) and PRINTEX 75 (17 nm) from Degussa; and #3950 from Mitsubishi Chemical Corporation.

Specific examples of commercially available coarse-grained carbon blacks include Thermal black (270 nm) from Cancarb and RAVEN MTP (275 nm) from Columbian Chemicals Company.

When two carbon blacks having different average particle sizes are used in the back coat layer, the ratio (weight ratio) between a fine-grained carbon black of 10-20 nm and a coarse-grained carbon black of 230-300 nm is preferably in the range of 98:2-75:25, more preferably 95:5 -85:15.

The content of a carbon black (the total amount of two types of carbon blacks, if used) in the back coat layer normally ranges from 30 to 80 parts by weight, preferably 45 to 65 parts by weight per 100 parts by weight of binders.

Preferably, two inorganic powders having different hardnesses are used in combination.

Specifically, a soft inorganic powder having a Mohs hardness of 3-4.5 and a hard inorganic powder having a Mohs hardness of 5-9 are preferably used. The addition of a soft inorganic powder having a Mohs hardness of 3-4.5 ensures stabilization of the friction coefficient during repeated running. In addition, tape-guiding poles cannot be worn in this range of hardness. This inorganic powder preferably has an average particle size in the range of 30-50 nm.

Soft inorganic powders having a Mohs hardness of 3-4.5 include, for example, calcium sulfate, calcium carbonate, calcium silicate, barium sulfate, magnesium carbonate, zinc carbonate and zinc oxide. These can be used alone or as a combination of two or more of them. Among them, calcium carbonate is especially preferred.

The content of a soft inorganic powder in the back coat layer is preferably in the range of 10-140 parts by weight, more preferably 35-100 parts by weight per 100 parts by weight of carbon blacks.

The addition of a hard inorganic powder having a Mohs hardness of 5-9 increases the strength of the back coat layer to improve running durability. When the inorganic powder is used with a carbon black or said soft inorganic powder, a strong back coat layer resistant to repeated sliding can be obtained. The addition of the inorganic powder confers a moderate abrasive force to reduce chips deposited on tape-guiding poles or the like. Especially when they are combined with the soft inorganic powder (among others, calcium carbonate), sliding properties against guide poles having a rough surface are improved so that the friction coefficient of the back coat layer can also be stabilized.

Hard inorganic powders preferably have an average particle size in the range of 80-250 nm (more preferably, 100-210 nm).

Hard inorganic powders having a Mohs hardness of 5-9 include, for example, α-iron oxide, α-alumina and chromium oxide (Cr₂O₃) . These powders may be used alone or in combination. Among them, α-iron oxide or α-alumina is preferred. The content of the hard inorganic powder is normally 3-30 parts by weight, preferably 3-20 parts by weight per 100 parts by weight of carbon blacks.

When said soft and hard inorganic powders are used in combination in the back coat layer, they are preferably selected to have a difference in hardness of 2 or more (more preferably, 2.5 or more, especially 3 or more).

Preferably, the back coat layer contains two inorganic powders having different Mohs hardnesses and specific average particle sizes as defined above and two carbon blacks having different average particle sizes as defined above. Especially in this combination, calcium carbonate is preferably contained as a soft inorganic powder.

The back coat layer can contain a lubricant that can be appropriately selected from those mentioned above as suitable for use in the nonmagnetic or magnetic layer. The back coat layer normally contains a lubricant in the range of 1-5 parts by weight per 100 parts by weight of binders.

[Nonmagnetic Flexible Substrate]

Magnetic recording media of the present invention have the following thickness structure. The nonmagnetic substrate suitably has a thickness of 2-100μm, preferably 2-80 μm. For floppy disks, the nonmagnetic substrate suitably has a thickness of 20-800 μm, preferably 25-70 μm. For computer tapes, the nonmagnetic substrate suitably has a thickness of 3.0-10 μm, preferably 3.0-8.0 μm, more preferably 3.0-5.5 μm.

Suitable nonmagnetic flexible substrates for use herein may be known films made of polyesters such as polyethylene terephthalate, polyethylene naphthalate; polyolefins; cellulose triacetate; polycarbonates; polyamides; polyimides; polyamides-imides; polysulfons; aramids; aromatic polyamides, etc. These substrates may be preliminarily subjected to corona discharge treatment, plasma treatment, adhesion-enhancing treatment, heat treatment, dust removal or the like.

In order to achive the object of the present invention, the surface roughness profile of the nonmagnetic substrate should freely be controlled by the size and amount of the filler added to the substrate. Examples of these fillers include oxides or carbonates of Ca, Si, Ti or the like and acrylic or other organic fine powders. Preferably, substrates have a maximum height Srmax of 1 μm or less, a ten point average roughness SRz of 0.5 μm or less, a peak height relative to the center plane SRp of 0.5 μm or less, a valley depth relative to the center plane SRv of 0.5 μm or less, an areal percentage relative to the center plane SSr of 10% or more but 90% or less, and an average wavelength Sλa of 5 μm or more but 300 μm or less. In order to obtain desired electromagnetic characteristics and durability, minute projections should be formed on the surfaces of these substrates. Normally, surface profile can be controlled by adding and dispersing a filler into resins forming the substrate in the range of 0 to 2000 particles having an average particle diameter of 0.01-0.2 μm per mm². In this case, coarse projections are formed by normally existing coarse particles in the particle size distribution or agglomerated particles.

Substrates used herein preferably have 100 or less, more preferably 80 or less, still more preferably 50 or less projections having a height of 0.273 μm or more per 100 cm².

Nonmagnetic substrates used herein preferably have an F-5 value of 5-50 Kg/mm², and a thermal shrinkage of 3% or less, more preferably 1.5% or less at 100° C. for 30 minutes, or preferably 1% or less, more preferably 0.5% or less at 80° C. for 30 minutes. Preferably, the break strength is 5-100 kg/mm² and the modulus of elasticity is 100-2000 kg/mm². The thermal expansion coefficient is 10⁻⁴-10⁸/°C., preferably 10⁻⁵-10⁻⁶/°C. The hygroscopic expansion coefficient is 10 ⁻⁴/RH % or less, preferably 10⁻⁵/RH % or less. These thermal, dimensional and mechanical characteristics are preferably almost equal in various directions in the plane of a substrate within a deviation of 10%.

[Preparation Process of Magnetic Recording Media]

Magnetic recording media of the present invention can be prepared by applying/drying coatings for forming various layers. The process for preparing a coating comprises at least a kneading step, a dispersing step and a mixing step optionally added before or after the former steps. Each step may be separated into two or more stages. All the materials used herein such as a ferromagnetic powder, a binder, a carbon black, an abrasive, an antistatic agent, a lubricant and a solvent may be added at the beginning of or during any steps. Moreover, divided portions of each material may be added at two or more steps. For example, divided portions of a polyurethane may be added at the kneading step, the dispersing step, and the mixing step for controlling viscosity after dispersion.

Organic solvents used in the process for preparing a magnetic recording medium of the present invention include ketones such as acetone, methyl ethyl ketone, methyl isobutyl ketone, diisobutyl ketone, cyclohexanone, isophorone and tetrahydrofuran; alcohols such as methanol, ethanol, propanol, butanol, isobutyl alcohol, isopropyl alcohol and methylcyclohexanol; esters such as methyl acetate, butyl acetate, isobutyl acetate, isopropyl acetate, ethyl lactate and glycol acetate; glycol ethers such as glycol dimethyl ether, glycol monoethyl ether and dioxane; aromatic hydrocarbons such as benzene, toluene, xylene, cresol and chlorobenzene; chlorinated hydrocarbons such as methylene chloride, ethylene chloride, carbon tetrachloride, chloroform, ethylene chlorohydrin and dichlorobenzene; N,N-dimethylformamide; and hexane, which may be used in any ratio. These organic solvents need not be 100% pure but may contain impurities such as isomers, unreacted materials, side reaction products, decomposition products, oxides and moisture in addition to main components. The content of these impurities is preferably 30% or less, more preferably 10% or less. Organic solvents used herein are preferably the same type in magnetic and nonmagnetic layers, but may be added in varying amounts. A solvent having a high surface tension such as cyclohexane or dioxane is used in the nonmagnetic layer to increase coating stability, more specifically, it is important that the arithmetic mean of solvent compositions in the upper layer is not less than the arithmetic mean of solvent compositions in the lower layer. Somewhat high polarity is preferred to improve dispersibility, so that solvent compositions preferably contain 50% or more of solvents having a permittivity of 15 or more. The dissolution parameter is preferably 8-11.

Although it is a matter of course that known manufacturing techniques can be applied as a part of the process to prepare a magnetic recording medium of the object of the present invention, a magnetic recording medium having a high residual magnetic flux density (Br) can be obtained by using an apparatus having a high kneading power such as a continuous kneader or a pressure kneader. When a continuous kneader or a pressure kneader is used, a ferromagnetic powder is kneaded with all or a part of a binder (preferably 30% or more of the total binders) in the range of 15-500 parts by weight per 100 parts by weight of the ferromagnetic powder. The details of these kneading processes are described in JP-A No. 106338/89 and 79274/89. The related description of this publication is incorporated herein by reference. For preparing solutions for lower nonmagnetic layers, it is desirable to use dispersion media having a high specific gravity, preferably zirconia beads.

A coating solution for forming a nonmagnetic layer containing a nonmagnetic powder and a binder and a coating solution for forming a magnetic layer containing a ferromagnetic powder and a binder can be simultaneously or sequentially applied on a nonmagnetic flexible substrate to form a magnetic layer on a nonmagnetic layer, and then subjected to smoothing and magnetic orientation while the coating layers are still wet.

The following apparatus and method can be used to apply a multilayer magnetic recording medium as described above.

(1) The lower layer is initially applied using a coater commonly used for magnetic coating such as a gravure coater, roller coater, blade coater or extrusion coater, and the upper layer is then applied using a substrate-pressurizing extrusion coater disclosed in JP-B No. 46186/89 and JP-A Nos. 238179/85 and 265672/90 while the lower layer is still wet. The related descriptions of these publications are incorporated herein by reference.

(2) The upper and lower layers are applied almost simultaneously using a single coating head having two slits for passing coating solutions as disclosed in JP-A Nos. 88080/88, 17971/90 and 265672/90. The related descriptions of these publications are incorporated herein by reference.

(3) The upper and lower layers are applied almost simultaneously using an extrusion coater having back-up rolls as disclosed in JP-A No. 174965/90. The related description of this publication is incorporated herein by reference.

In order to prevent electromagnetic characteristics loss or the like of magnetic recording media due to agglomeration of magnetic particles, coating solutions in the coating head should desirably be subjected to shearing by the method as disclosed in JP-A Nos. 95174/87 and 236968/89. In addition, coating solutions should have a viscosity satisfying the numerical range disclosed in JP-A No. 8471/91. The related descriptions of these publications are incorporated herein by reference.

Smoothing can be performed by applying a stainless plate against the surface of the coating layer on the web, for example. Alternative suitable means include using a solid smoother as disclosed in JP-B No. 57387/85, or measuring the coating solution scraped with a rod still or rotating in the reverse direction to the web running direction, or smoothing the surface of the coating solution film by surface contact with a flexible sheet, etc. The related description of this publication is incorporated herein by reference.

For magnetic orientation, a solenoid of 100 mT (1000 G) or more and a cobalt magnet of 200 mT (2000 G) or more are preferably used in combination with the facing sides being of the same polarity. When the present invention is applied as a disk medium, an orientation method rather randomizing orientation is required.

Suitable calender rolls include heat-resistant plastic rolls made of epoxy, polyimide, polyamide, polyimide-amide or the like. A series of metal rolls may also be used. The process temperature is preferably 70° C. or more, more preferably 80° C. or more. Suitably, the linear pressure is preferably 200 kg/cm, more preferably 300 kg/cm or more. The friction coefficient of magnetic recording media of the present invention against SUS420J on the magnetic layer side and the opposite side is preferably 0.5 or less, more preferably 0.3 or less, and the surface specific resistance is preferably 10⁴-10¹² ohms/sq. The modulus of elasticity of the magnetic layer at 0.5% elongation in both running and width directions is preferably 0.98-19.6 GPa (100-2000 kg/mm²), and the strength at break is preferably 0.98-29.4 GPa (1-30 kg/cm²) The modulus of elasticity of magnetic recording media in both running and width directions is preferably 0.98-14.7 GPa (100-1500 kg/mm²), the residual elongation is preferably 0.5% or less, and the thermal shrinkage at any temperature of 100° C. or below is preferably 1% or less, more preferably 0.5% or less, most preferably 0.1% or less. The glass transition temperature (i.e. the temperature at which the loss elastic modulus of dynamic viscoelasticity measured at 110 Hz is maximum) of the magnetic layer is preferably 50 ° C. or more but 120° C. or less, and that of the lower layer is preferably 0° C. to 100° C. The loss elastic modulus is preferably in the range of 1×10⁷-8×10⁸ N/cm² (1×10⁸-8×10⁹ dyn/cm²), and the loss tangent is preferably 0.2 or less. Excessive loss tangents tend to cause adhesion failure.

The residual solvent content in the magnetic layer is preferably 100 mg/m² or less, more preferably 10 mg/M² or less. The void volume in both lower and magnetic layers is preferably 30% by volume or less, more preferably 20% by volume or less. The void volume is preferably as low as possible to attain high output, but may be preferably more than a specific value for some purposes. For example, higher void volumes are often preferred for better running durability in magnetic data recording media which set importance on repeated use. Magnetic characteristics of magnetic recording media of the present invention are expressed as the squareness in the tape running direction of 0.70 or more, preferably 0.80 or more, more preferably 0.90 or more measured under a magnetic field of 5 kOe.

The squarenesses (SQ) in two directions perpendicular to the tape running direction are preferably 80% or less of the squareness in the running direction. The SFD (Switching Field Distribution) of the magnetic layer is preferably 0.6 or less.

In magnetic recording media of the present invention having a lower layer and an upper magnetic layer, these physical characteristics can obviously vary from lower to magnetic layers to meet the purpose. For example, the magnetic layer may have a relatively high modulus of elasticity to improve running durability while the lower layer may have a lower modulus of elasticity than that of the magnetic layer to improve the head touch of the magnetic recording medium. Physical characteristics of two or more magnetic layers can be chosen on the basis of known techniques relating to multilayer magnetic systems. For example, many inventions as disclosed in JP-B No. 2218/62 and JP-A No. 56228/83 propose to use an upper magnetic layer having an Hc higher than that of the lower layer. The related descriptions of these publications are incorporated herein by reference. According to the present invention, recording can be achieved by using a thin magnetic layer even if the magnetic layer has a higher Hc.

The present disclosure relates to the subject matter contained in Japanese Patent Application No. 2000-94605, filed on Mar. 30, 2000, which is expressly incorporated herein by reference in its entirety.

### [EXAMPLES]

<Evaluation of computer tapes>

| Coating A (for upper layer) | | |
|---|---|---|
| Ferromagnetic metal powder | 100 | parts |
| (Co/Fe: 24 at %, Al/Fe: 10 at %, Y/Fe: 10 at %, | | |
| Hc: 190244 A/m (2390 Oe) , σs: 140 A, | | |
| m²/kg (140 emu/g), | | |
| Sbet: 57 m²/g, Major axis length: 0.08 μm, | | |
| Crystallite size: 130 angstrom, PH: 9) | | |
| Vinyl chloride resin | 5 | parts |
| (MR-110 manufactured by Nippon Zeon, Co., Ltd.) | | |
| Polyester-polyurethane resin | 3 | parts |
| (Molecular weight: 35000, | | |
| Neopentyl glycol/caprolactone polyol/MDI = | | |
| 0.9/2.6/1 containing 1 × 10⁻⁴ eq/g of —SO₃Na | | |
| group) | | |
| Carbon black (mean particle size 80 nm) | 0.5 | parts |
| α-Al₂O₃ (mean particle size 0.1 KIm) | 5 | parts |
| Phenylphosphonic acid | 3 | parts |
| Stearic acid (technical grade) | 0.5 | parts |
| sec-Butyl stearate (technical grade) | 1.5 | parts |
| Cyclohexanone | 30 | parts |
| Methyl ethyl ketone | 90 | parts |
| Toluene | 60 | parts |
| Coating B (for lower layer) | | |
| α-Fe₂O₃ | 80 | parts |
| (Average major axis length: 0.1 μm, | | |
| Sbet: 48 m²/g, pH: 8, | | |
| Al₂O₃ is present on the surface at 1% by weight of the | | |
| total particles) | | |
| Carbon black (mean primary particle size 16 nm) | | |
| Vinyl chloride resin | 5 | parts |
| (MR-110 manufactured by Nippon Zeon, Co., Ltd.) | | |
| Polyester-polyurethane resin | 5 | parts |
| (Molecular weight: 35000, | | |
| Neopentyl glycol/caprolactone polyol/MDI = | | |
| 0.9/2.6/1 containing 1 × 10⁻⁴ eq/g of —SO₃Na | | |
| group) | | |
| Stearic acid | 1 | part |
| sec-Butyl stearate (technical grade) | 1 | part |
| Cyclohexanone | 50 | parts |
| Methyl ethyl ketone | 100 | parts |
| Toluene | 50 | parts |

For each of the above coating formulations for upper and lower layers, pigments, polyvinyl chloride, phenylphosphonic acid and 50% of each solvent were kneaded with a kneader and then dispersed with polyurethane resin and the remaining components using a sand mill. The resulting dispersion was combined with a polyisocyanate (Coronate L from Nippon Polyurethane Industry Co., Ltd.) in an amount of 1 part for the coating solution for upper layer or 3 parts for the coating solution for lower layer and further combined with 40 parts of a mixed solvent of methyl ethyl ketone and cyclohexanone, and the mixed solution was passed through a filter having an average pore diameter of 1 μm to prepare coating solution A for forming an upper layer and coating solution B for forming a lower layer.

Then, the resulting coating solution A for upper layer and coating solution B for lower layer were applied by simultaneous multilayer coating to form a lower layer into a dried thickness of 1.8 μm followed by a magnetic layer into a specific dried thickness (Table 1) on a PET film having a thickness of 6 μm, and then oriented with a cobalt magnet having a magnetic force of 477600 A/m(6000 Oe) and a solenoid having a magnetic force of 477600 A/m (6000 Oe) while the coating solutions are still wet. The substrates used were PET films having about 30projections having a height of 0.273-0.546 μm per 100 cm² in Examples 1-3 and Comparative examples 1 and 3 and about 250 such projections per 100 cm² in Comparative example 2.

After the upper and lower coating layers were dried, coating C for back coat layer shown below was applied into a dried thickness of 0.5 μm on the side of the substrate opposite to the upper and lower coating layers. The assembly was dried, and then smoothed through a 7-stage calender at a temperature of 90° C. and at a speed of 200 m/min.

| Coating C (for back coat layer) | | |
|---|---|---|
| Fine-grained carbon black | 100 | parts |
| (Mean particle size: 17 nm, | | |
| BP-800 from Cabot) | | |
| Coarse-grained carbon black | 10 | parts |
| (Mean particle size: 270 nm, | | |
| Thermal Black from Cancarb Limited) | | |
| α-Fe₂O₃ | 15 | parts |
| (Mean particle size: 0.11 μm, | | |
| TF100 from Toda Kogyo K.K.) | | |
| Nitrocellulose resin | 140 | parts |
| Polyurethane resin | 15 | parts |
| Polyester resin | 5 | parts |
| Polyi socyanate resin | 40 | parts |
| Copper oleate | 5 | parts |
| Copper phthalocyanine | 5 | parts |

Thus formed magnetic tape web was heated at 70° C. for 48 hours to cure the polyisocyanate compound.

Then, the web was slit in a width of 3.8 mm while trimming both sides from the web roll. The slit products of Examples 1-3 and Comparative examples 1 and 2 were polished/cleaned on the surface of the magnetic layer.

(1) Count of projections on the surface of the medium

Projections were detected and marked in an area of 30 cm×30 cm on the surface of the medium with a differential interference microscope. Then, the heights and widths of the projections were measured with HD-2000 from WYKO (objective lens 50×, intermediate lens 0.5×, measurement range 242 μm×184 μm) to count the number of projections having a diameter of 5-100 μm and a height of 100 nm or more.

(2) Determination of TA counts

Tapes were run at a relative feeding speed of 1 m/s in a tape running system equipped with a fixed MR head (8 tracks). Six tapes of 60 m in length were evaluated to determine the number of TA peaks corresponding to H/Ep >2 where Ep is a reproducing output and H is a TA peak output during recording/reproducing at λ=1 μm. Tapes showing 5 or less TA counts were considered to be good.

(3) Reproducing output, CNR

CNR was measured with a drum tester using an MIG head having a Bs of 1.8 T and a gap length of 0.15 μm for recording and an MR head for reproducing. The reproducing spectrum was observed with a spectrum analyzer manufactured by Shibasoku Co., Ltd. at a head/medium relative speed of 10.5 m/sec during recording/reproducing and a single frequency of 21 MHz to calculate the reproducing output and CNR (the ratio of carrier output at 21 MHz to noise at 19 MHz).

The measurement results are shown in Table 1.

TABLE 1

| | | | | Number of | | | |
|---|---|---|---|---|---|---|---|
| | Thickness | Projections | | surface | TA | Reproducing | |
| | of upper | on base | Surface | projections | counts | output | CNR |
| | layer (μm) | (#/100 cm²) | treatment | (#/900 cm²) | (#) | (dB) | (dB) |
| Ex. 1 | 0.03 | 30 | Yes | 5 | 2 | 4.1 | 4.3 |
| Ex. 2 | 0.06 | 30 | Yes | 7 | 2 | 4.5 | 4.1 |
| Ex. 3 | 0.10 | 30 | Yes | 6 | 1 | 3.9 | 3.8 |
| Com. ex. 1 | 0.15 | 30 | Yes | 5 | 0 | 0 | 0 |
| Com. ex. 2 | 0.06 | 250 | Yes | 16 | 17 | 4 | 3.5 |
| Com. ex. 3 | 0.06 | 30 | No | 15 | 15 | 4.3 | 4 |

As shown in Table 1, magnetic recording tapes of Examples 1-3 having a magnetic layer (upper layer) having a thickness in the range of 0.02-0.1 μm and containing 10 or less projections having a diameter of 5-100 μm and a height of 100 nm or more per 900 cm² on the surface of the magnetic layer are better in reproducing output and CNR than the magnetic recording tape of Comparative example 1 having a magnetic layer (upper layer) having a thickness outside the range of 0.02-0.1 μm though it has 10 or less projections having a diameter of 5-100 μm and a height of 100 nm or more per 900 cm² on the surface of the magnetic layer. Magnetic recording tapes of Examples 1-3 are improved in thermal asperity over magnetic recording media of Comparative examples 2 and 3 having a magnetic layer (upper layer) having a thickness in the range of 0.02-0.1 μm but having more than 10 projections with a diameter of 5-100 μm and a height of 100 nm or more per 900 cm² on the surface of the magnetic layer.

<Evaluation of floppy disks>

| Coating D (for upper layer) | | |
|---|---|---|
| Ferromagnetic metal powder | 100 | parts |
| (Co/Fe: 24 at %, Al/Fe: 10 at %, Y/Fe: 10 at %, | | |
| Hc: 190244 A/m (2390 Oe) , Os: 140 A. m²/kg (140 emu/g) | | |
| Sbet: 57 m²/g, Major axis length: 0.08 μm, | | |
| Crystallite size: 130 angstrom, pH: 9) | | |
| Vinyl chloride copolymer | 10 | parts |
| (MR-110 manufactured by Nippon Zeon, Co., Ltd.) | | |
| Polyurethane resin | 4 | parts |
| (UR8200 from Toyobo) | | |
| Carbon black (#50 from Asahi Carbon) | 2 | parts |
| α-Al₂O₃ (mean particle size 0.15 μm) | 10 | parts |
| Phenylphosphonic acid | 3 | parts |
| iHDS (isohexadecyl stearate) | 5 | parts |
| Oleic acid | 1 | part |
| Stearic acid | 1 | part |
| Methyl ethyl ketone | 180 | parts |
| Cyclohexanone | 110 | parts |
| Coating E (for lower layer) | | |
| α-Fe₂O₃ | 100 | parts |
| (Average major axis length: 0.15 μm, | | |
| Sbet: 50 m²/g, PH: 9, | | |
| Al₂O₃ is present on the surface at 1% by weight of the | | |
| total particles) | | |
| Carbon black | 20 | parts |
| (CONDUCTEX SCU from Columbian Carbon Chemicals) | | |
| Vinyl chloride copolymer | 16 | parts |
| (MR-100 manufactured by Nippon Zeon, Co., Ltd.) | | |
| Polyure thane resin | 7 | parts |
| (UR8200 from Toyobo) | | |
| Phenylphosphonic acid | 3 | parts |
| iHDS (isohexadecyl stearate) | 6 | parts |
| Oleic acid | 1 | part |
| Stearic acid | 1 | part |
| Methyl ethyl ketone | 200 | parts |
| Cyclohexanone | 50 | parts |

For each of said coatings D and E, various components were kneaded with a kneader and then dispersed with 1 part of diamond fine particles using a sand mill. Each of the resulting dispersions for upper and lower layers was combined with a paste (SLH55 from Sumitomo Chemical) containing a-alumina (HIT55 from Sumitomo Chemical) dispersed in a vinyl chloride copolymer (MR110 from Nippon Zeon) in an amount of 5 parts as α-alumina as well as a polyisocyanate in an amount of 5 parts for the dispersion for upper layer or 13 parts for the dispersion for lower layer, and further combined with 70 parts of cyclohexanone, and the mixed solution was passed through a filter having an average pore diameter of 1 μm to prepare coating D for forming an upper layer and coating E for forming a lower layer.

The resulting coating solution D for upper layer and coating solution E for lower layer were applied by simultaneous multilayer coating to form a lower layer into aspecific dried thickness (Table2) immediately followed by a magnetic layer into a specific dried thickness (Table 2) on a PET film having a thickness of 62 μm and a center plane average surface roughness of 3 nm. Both layers still wet were randomly oriented through an alternating magnetic field generator having two magnetic field strengths of 25 mT (250 G) at a frequency of 50 Hz and 12 mT (120 G) at a frequency of 50 Hz and dried. Then, the other side of the substrate was coated, oriented and dried in the same manner. The substrates used were PET films having about 30 projections having a height of 0.273-0.546 μm per 100 cm² in Examples 1-3 and Comparative examples 1-3 and about 5 such projections per 100 cm² in Comparative example 4.

Then, the assembly was passed through a 7-stage calender at a temperature of 90° C. and a linear pressure of 300 kg/cm, and then stamped out into a 3.7-inch disk. After varnishing (Examples 1-3 and Comparative example 3) or not (Example 4 and Comparative examples 1 and 2), the disk was equipped with necessary components and inserted into a Zip-disk cartridge from Iomega, USA to give a 3.7-inch floppy disk.

(1) Determination of the number of projections on the surface of the medium

Projections were counted as described for computer tapes.

(2) TA counts

TA counts were determined using a spin stand SS60 from Kyodo Denshi System and RWA-1601 from GUZIK with an SAL-MR head (WRITE WIDTH 2.4 μm, GAP 0.4 μm, READ WIDTH 1.9 μm, GAP 0.24 μm, ABS Negative Pressure) under the following conditions.

Ten disks were evaluated for both sides to determine the number of TA peaks corresponding to H/Ep>2 where Ep is a reproducing output and H is a TA peak output during recording/reproducing at a linear recording density of 100 KFCI and a linear speed of 6.3 m/sec. Disks showing 5 or less TA counts were considered to be good.

(3) SN ratio

Said reproducing output and DC noise were measured at the position of a radius of 30 mm to determine the SN ratio as compared with Comparative example 1 (0 dB).

The measurement results are shown in Table 2.

TABLE 2

| | | | | | Number of | | |
|---|---|---|---|---|---|---|---|
| | Thickness | Thickness | Projections | | surface | TA | |
| | of lower | of upper | on base | Surface | projections | counts | S/N |
| | layer (μm) | layer (μm) | (#/900 cm²) | treatment | (#/100 cm²) | (#) | (dB) |
| Ex. 1 | 1.8 | 0.03 | 30 | Yes | 10 | 3 | 1.8 |
| Ex. 2 | 1.8 | 0.06 | 30 | Yes | 8 | 2 | 1.9 |
| Ex. 3 | 1.8 | 0.10 | 30 | Yes | 7 | 1 | 1.5 |
| Ex. 4 | 1.8 | 0.06 | 5 | No | 5 | 0 | 2.2 |
| Com. ex. 1 | 2.5 | 0.15 | 30 | No | 10 | 4 | 0 |
| Com. ex. 2 | 1.8 | 0.06 | 30 | No | 34 | 38 | 1.8 |
| Com. ex. 3 | 1.8 | 0.15 | 30 | Yes | 7 | 1 | 0.1 |

As shown in Table 2, floppy disks of Examples 1-4 having a magnetic layer (upper layer) having a thickness in the range of 0. 02-0.1 μm and having 10 or less projections with a diameter of 5-100 μm and a height of 100 nm or more per 900 cm² on the surface of the magnetic layer are better in S/N than floppy disks of Comparative examples 1 and 3 having a magnetic layer (upper layer) having a thickness outside the range of 0.02-0.1 μm though they have 10 or less projections with a diameter of 5-100 μm and a height of 100 nm or more per 900 cm² on the surface of the magnetic layer. Floppy disks of Examples 1-4 are improved in thermal asperity over the floppy disk of Comparative example 2 having a magnetic layer (upper layer) having a thickness in the range of 0.02-0.1 μm but having more than 10 projections having a diameter of 5-100 μm and a height of 100 nm or more per 900 cm² on the surface of the magnetic layer.

According to the present invention, a magnetic recording medium for high-density magnetic recording suitable for reproducing with an MR, such as a magnetic recording tape or magnetic recording floppy, which has improved electromagnetic characteristics, especially high-density recording characteristics and thermal asperity can be provided.

What is claimed is:

1. A magnetic recording medium comprising a nonmagnetic lower layer and a magnetic layer containing a ferromagnetic powder and a binder provided in this order on a nonmagnetic substrate wherein
said magnetic layer has an average thickness in a range of from 0.02 μm to 0.1 μm and
said magnetic layer has 10 or less projections having a diameter in a range of from 5 μm to 100 μm and a height equal to or more than 100 nm per 900 cm² on its surface.

2. The magnetic recording medium according to claim 1, wherein said ferromagnetic powder is a ferromagnetic metal powder having an average major axis length equal to or less than 0.1 μm and an aspect ratio equal to or more than 5.

3. The magnetic recording medium according to claim 1, wherein said magnetic recording medium is a tape or disk for a digital signal recording system equipped with an MR reproducing head.

4. The magnetic recording medium according to claim 1, wherein said magnetic layer has an average thickness in a range of from 0.03 μm to 0.09 μm.

5. The magnetic recording medium according to claim 1, wherein said nonmagnetic lower layer has a thickness in a range of from 0.2 μm to 5.0 μm.

6. The magnetic recording medium according to claim 1, wherein said nonmagnetic lower layer has a thickness in a range of from 0.3 μm to 3.0 μm.

7. The magnetic recording medium according to claim 1, wherein said nonmagnetic lower layer has a thickness in a range of from 1.0 μm to 2.5 μm.
